(19) United States
(12) Patent Application Publication
(10) Pub. No.: US 2009/0004367 A1
(43) Pub. Date: Jan. 1, 2009

(54) CERAMIC GLAZE COATING STRUCTURE OF A CHIP ELEMENT AND METHOD OF FORMING THE SAME

(75) Inventors: Shih-Kwan LIU, Zhunan Town (TW); Chun-Pin Huang, Zhunan Town (TW); Yu-Chin Shu, Zhunan Town (TW)

Correspondence Address: LADAS & PARRY LLP, 26 WEST 61ST STREET, NEW YORK, NY, 10023, US

(73) Assignee: INPAQ TECHNOLOGY CO., LTD..

(21) Appl. No.: 12/172,478

(22) Filed: Jul. 14, 2008

Related U.S. Application Data
(62) Division of application No. 11/403,777, filed on Apr. 13, 2006.

(30) Foreign Application Priority Data
Apr. 15, 2005 (TW) 094112096

(51) Int. Cl. B05D 3/14

(52) U.S. Cl. 427/79; 427/376.2

(57) ABSTRACT

A ceramic glaze-coating structure of a chip element and a method of forming the same are provided. In the ceramic glaze-coating structure, a high-density, smooth, and high-impedance ceramic glaze is coated on the body of an element. As for the terminal electrode part, the unique firing characteristics between the material of the terminal electrode (e.g., conductive compositions) and the ceramic glaze are utilized, such that the ceramic glaze layer between the surface of the terminal electrode or the terminal electrode and the ceramic body is absorbed and then removed by sintering; thus, the ceramic glaze coating structure of a chip element with only the element body being coated is formed.

### FIELD OF THE INVENTION

The present invention relates to a ceramic laminated chip element, and more particularly, to a ceramic laminated chip element with the body made of a semiconductor ceramic material or a ceramic material without high insulation, wherein a layer of dense, smooth ceramic glaze with high insulation impedance is provided on the element body except for the terminal electrodes, such that the terminal electrodes of the chip element are achieved through a plating process.

### BACKGROUND OF THE INVENTION

A chip element including a single chip (shown in FIG. 1A) and array-type chip (shown in FIG. 1B) has been widely applied in the circuits of various electronic systems and products. The basic structure of a chip element comprises a body 1, inner electrodes 2 disposed within the body 1, terminal electrodes 3 disposed at opposite ends of the body, and welding interface layers 5 with a desirable welding property. The chip element utilizes different materials at different parts depending upon the requirements for the part's physical property, for example, a capacitor in a single-chip type or array-type chip element is made of ceramic media material, a magnetic bead is made of a ceramic iron powder material, and a rheostat is made of a ceramic semiconductor material.

In general, most chip elements have their terminal electrodes jointed with the system circuit substrate through a soldering process, such that the chip elements function well in the electronic circuit.

In the circumstance that these relevant materials are designed to be used in a high-voltage condition, even if the single chip and array-chip type capacitors are made of ceramic media materials with excellent insulation properties, the surfaces of the elements still have the problem of poor insulation impedance in practical applications. As for single chip type and array chip type magnetic beads and rheostats made of materials with lower resistance, in addition to the insulation impedance problem occurring on the element surface, other problems derived from the fabrication process of the elements occur.

Moreover, as for single chip and array chip type elements, if the insulation impedance on the element surface is not high enough, and a welding interface structure for terminal electrodes is required during fabrication, it is generally hard to fabricate terminal electrode structure with an excellent welding property due to the problem of the fabricating process, or a special process is used during the fabrication process in order to fabricate terminal electrodes that meet the welding property requirements. The above-mentioned circumstances both cause problems in the fabrication process or in the quality of the element.

Vitreous materials are often used as coatings for some substrates to improve the surface characteristics of the substrate, and further enhance the practicability and add more values, for example, the substrate is made to be more chemical resistant, more liquid or gas insulating, smoother, more friction resistant, and more abrasion resistant, and has preferred mechanical strength.

Vitreous coating is a thin film and vitreous material melted on the surface of the substrate. For a ceramic substrate, the coating is called ceramic glaze. If the substrate is a metal, the coating is called enamel.

To decide the application of the surface coating material, optical properties and the appearance are major concerns. As the vitreous coating may be transparent or opaque, high glossy or non-glossy, smooth, patterned, or textured, monochromatic or colorful, the requirements for various properties must considered to meet specific application demands.

Ceramic glaze is a vitreous coating applied on the surface of a ceramic substrate and has features similar to glass: no fixed chemical composition and no fixed melting point, but a melting temperature range. The ceramic glaze also does not have a fixed crystal structure, and many of its properties are very similar to solutions. Therefore, it is called a super-cool solution, which is a complicated mixture. Like other types of glass, the ceramic glaze contains a large amount of silicon oxide. If plenty of other materials are added, the glaze is melted at an expected temperature to generate the desired structure and color. As for glaze used for the substrate of electronic products, the glaze-firing temperature is normally between 600° C. and 900° C.

Taking advantage of the high fluidity and low surface tension of glaze at such a high temperature, the glaze penetrates and fills up pores on the surface of the ceramic substrate to be coated, thus forming a highly reliable insulation and protection layer.

The conductive compositions are common thick film materials, which are generally single metals of Ag, Pd, Pt, or metal alloys or metal mixtures derived therefrom When the conductive compositions, together with appropriate glass or oxides, are dispersed in an organic vehicle, a conductive paste is formed, which can be applied on the surface of the element to be coated by means of printing and/or dipping. Through a firing process at a temperature of higher than 500° C., the metal is attached to the surface of the element.

### DESCRIPTION OF THE PRIOR ART

As for ceramic laminated chip elements with bodies made of semiconductors or materials without high insulating resistance, there are seven conventional methods to solve the problem of fabricating a plating and welding interface layer on the surface of the terminal electrodes, which are described as follows in terms of fabricating methods and characteristics.

The first conventional method is to adjust plating conditions of the plating process, especially changing the form of the plating liquid. With this method, the surface of the ceramic body other than the terminal electrodes does not have a plating and welding interface layer 5 to be grown or attached thereon during the plating process of the body of an electronic element, and the element structure is shown in FIGS. 2A, 2B1, and 2B2. Though the welding interface layers 5 can be fabricated through plating in this method, a special plating production line is required, which is often not compatible with other relevant products. In addition to the increase in the investment, the method is disadvantageous in that the special plating waste water has to be treated with special methods, resulting in unnecessary disturbance to the manufacturer, and the equipment cost is increased as well.

The second conventional method is to fabricate an insulating coating layer 4 on a part of the electronic element that needs to be insulated, after terminal electrodes 3 have already been fabricated. With this method, the surface of the ceramic body 1 other than the terminal electrodes 3 does not have a plating and welding interface layer 5 to be grown or attached during the process of forming the welding interface layer 5, as shown in FIGS. 3A and 3B1. However, the disadvantages of this method lie in that, in addition to being limited by the structure of the fabricated terminal electrodes 3, and due to the substantially rectangular shape of ceramic laminated-chip type electronic elements, when the process for forming structures in this method is used to fabricate an electronic element, the element must be processed piece by piece, or surface by surface, resulting in a low fabricating speed and low yields of mass production. As the yield of the manufacturing equipment is low, a large investment in equipment is required to meet the manufacturing requirements, so the manufacturing cost is extremely high. In addition, this method cannot be applied for fabricating array chip type elements in large quantities, as shown in FIGS. 1B, 3A, and 3B2. When the insulated coating layer 4 is fabricated in an array-type chip element after the terminal electrodes 3 have already been formed, the parts to be insulated cannot be gradually coated step by step with processes and equipment for mass production. If this method is applied, the fabrication process is complicated, and the cost is extremely high.

As for this structure, Japanese Patent Publication Heisei 11-251120 describes a glass-insulating coating layer, as shown in FIG. 3. This method calls for performing the removing process at the locations where glass is not required, which increases the cost and complexity of the process. Similarly, this technique cannot be applied for fabricating array-chip elements in large quantity.

The third conventional method is similar to the second one. Referring to FIGS. 3A and 3B1 again, this method is to fabricate an insulating coating layer 4 on the part of an electronic element that needs to be insulated after terminal electrodes 3 have already been fabricated. However, the insulating layer is generated with chemical reactions in this method. By applying an agent that only reacts with the body but does not react with the terminal electrode layer, the entire element is dipped in the agent, which chemically reacts with the body, such that a layer of insulating material grows on the part of the surface of the body on which no electrode layer exists. As chemical reactions are utilized, even as for the array-chip type elements shown in FIGS. 1B, 3A, and 3B2, the coating layer also can be fabricated thereon. The most common example is ceramic laminated zinc oxide rheostat, which is treated with agents derived from phosphoric acid, and then the salt compounds with zinc phosphate as a main part are generated on the surface of the rheostat. However, the disadvantage of this method lies in that the obtained insulating layer has a rough surface, an uneven thickness, and sometimes has micro-pores on the surface. Through this method, the generated rough surface and micro-pores are embedded with silver from the terminal electrodes and tin from the plating additives during the plating process. If customers employ this method and widely apply it in circuit substrates, impurities such as flux and moisture are absorbed, which easily results in deterioration and failure of the elements.

The fourth conventional method relates to a coating layer structure of a chip element for Panasonic, Japan, as shown in FIGS. 4A, 4B1, and 4B2, which is another method of fabricating an insulating layer. In the structure, a high-temperature sintering at 900° C. or above is mainly performed on the glass phase used as a sintering agent in the ceramic body, such that the glass phase is extruded from the body, and stays on the surface of the element to form a glass layer. In other words, the glass layer is a part of the body 1. This method is characterized in that the glass layer is disposed between the terminal electrodes 3 and the body 1, and includes the exposed surface of the inner electrodes 2, but it does not exist at the joint part of the inner electrodes 2 and the terminal electrodes 3. The disadvantage of this method lies in that not all the ceramic element bodies require glass when being sintered, and when the ceramic elements are sintered, not all elements can extrude enough glass to cover the entire body. In addition, the glass extruded to cover the surface is not as flat and smooth as the ceramic glaze. Therefore, similar to the third conventional method, the problem that the impurities are embedded and absorbed in the rough surfaces also occurs in this method.

The fifth conventional method relates to Taiwan Patent Publication No. 447775 of the applicants, as shown in FIGS. 5A and 5B1, which is an insulating structure of ceramic laminated-chip type electronic elements, wherein in a laminated-chip type electronic element with semiconductors or materials without a high-insulation property as the body, a layer of insulating material is coated on the surfaces of the body. The insulating structure does not exist between the outer ends of the inner electrodes 2 and the terminal electrodes 3, but exists on the surfaces of both ends of the body 1. This insulating structure is fabricated by coating an insulating layer on the entire body 1 after the body 1 with the inner electrodes has already been formed and before the terminal electrodes 3 are formed. Therefore, the insulating layer exists on all the interfaces of the terminal electrodes 3 and the body 1, but does not exist between the exposed surface of the inner electrodes 2 and the terminal electrodes 3. This protection layer structure is the same as that of the fourth conventional method, and it is easily identified as not being a part of the ceramic body. This method is further characterized in that the coating layer at the joint part of the inner electrodes 2 and the terminal electrodes needs to be removed through sand blasting, laser, grinding, etching, etc., such that the inner electrodes 2 and the terminal electrodes 3 are electrically connected. Therefore, mechanisms or tools for removing the coating layer must be designed at the single case design level as for ceramic array-chip type electronic elements having terminal electrodes 3 with complicated pins.

The sixth conventional method is a structure of a chip type insulating layer and the method of fabricating the same disclosed in U.S. Pat. Nos. 5,750,264 and 5,866,196. The technical feature of the patents is that a metal film is formed on the surface of an element, and then it is oxidized through appropriate heat treatment to function as an oxide-protection layer. In this fabricating method, no oxide-protection layers are ensured to be formed on the surface of the terminal electrodes 3 in order to facilitate subsequent processes. Thus, the surface of the terminal electrodes 3 must be masked to prevent the oxide from forming thereon, and the masking process is not removed until the oxide-protection layer for the body is formed, so the process is complicated, and the cost is high.

Furthermore, the oxide-protection layer obtained with this method is not thick enough, and normally, the thickness is about 5 μm. Therefore, the oxide protection layer is easily abraded and damaged during plating, resulting in the decrease of reliability. If the oxide-protection layer is fabricated to be 5 μm or above in thickness, cracks easily occur, which also results in the decrease of reliability. To solve the problems described above, the two patents also disclose a method of fabricating a glass-protection layer on the surface of the oxide-protection layer of the element. However, with this method, the glass-protection layer must be fabricated after the plating process with special chemical solutions, so as to form a two-layered insulation layer.

The seventh conventional method relates to a structure of a chip-type glass-insulation layer and the method of fabricating the same disclosed in Japanese Patent JP5047513 and JP 6096907, as shown in FIG. 6. However, an element fabricated with this technique has glass formed oil the entire surface of the element, including the part where the terminal electrodes 3 are located. Thus, as the glass layer exists between the terminal electrodes 3 and the inner electrodes 2, unexpected impedance often occurs, resulting in low concentration of the electrical features of the element, and low production yield.

To enhance the electrical concentration, the glass-insulating layer has to be controlled under a certain thickness, and must not be thicker. Thus, when fabricating the welding interface, as the glass layer is not thick enough, it is easily abraded and damaged, so a special plating process must be employed, and so the cost of the plating process is increased.

### SUMMARY OF THE INVENTION

To solve the problems of conventional ceramic laminated single chip type and array-chip type electronic elements, the present invention provides an insulating structure of ceramic laminated chip elements and a coating method thereof, wherein semiconductor materials or materials without high-insulating resistance are used as the body of the ceramic laminated chip element, and then, a layer of ceramic glaze is formed on the body of the electronic element before or after the terminal electrodes 3 are fabricated, such that the terminal electrodes 3 of the electronic element may form a welding interface through a plating process.

The ceramic glaze-coating structure of ceramic laminated chip elements and the method of forming the same according to the present invention allows the terminal electrodes 3 of the electronic elements and the plating process to be suitable for any plating line, without requiring adjustment of the plating conditions of the plating process or any special plating line. Also, a large yield of electronic elements can be achieved with very low equipment cost through the operation mode of batch coating. In addition, the material for forming the terminal electrodes is only the common low-cost material, which is one object of the present invention.

The ceramic glaze-coating structure of ceramic laminated chip elements according to the present invention is different from the common electronic elements in that the insulated coating layer 4 is fabricated on places to be insulated after the terminal electrodes are completed, such that all of the electronic elements must be processed individually. Thus, solving the problems of slow speed and low yield is another object of the present invention.

In the ceramic glaze-coating structure of ceramic laminated chip elements according to the present invention, the welding-interface layer is fabricated on the surface of the terminal electrodes 3 through a common plating process, so the terminal electrode material with special noble metals is not required. Thus, the production will not be influenced by the price fluctuation of noble metals, which is still another object of the present invention.

In the ceramic glaze-coating structure of ceramic laminated chip elements according to the present invention, due to the high fluidity and low surface tension of the glaze at high temperature, the glaze penetrates and fills up the pores on the surface of the body for chip element, so as to form an insulation and protection layer with high reliability. As ceramic glaze is sintered on the surface at high temperature, the surface has all characteristics of the ceramic glaze, such as high density, smoothness, abrasion resistance, and high-temperature resistance. The common insulating and coating materials of other conventional techniques are not used herein, such as polymers, compounds derived from zinc phosphate, silicon dioxide, or other oxides, which normally have the surface structure and characteristics of roughness, porousness, poor high-temperature resistance, and poor organic solvent resistance. As the ceramic glaze-coating structure does not have a rough surface, it does not adhere silver from the terminal electrodes or metals from plating additives due to collision during plating, and is not influenced by any organic solvent, flux, or moisture. The most significant difference between the ceramic glaze layer and the polymer-insulating layer lies in that the ceramic glaze layer still remains on the ceramic body even at a temperature of over 300° C.

In the ceramic glaze-coating structure of ceramic laminated chip elements according to the present invention, the ceramic glaze on the surface of the terminal electrodes 3 and that between the terminal electrodes 3 and the body 1 are removed without requiring the process of sand blasting, laser, grinding, etching, etc., by a sintering reaction between an appropriately selected conductive composition and an appropriately selected glaze. Thus, there are no ceramic glaze layers on the surface of the region for the terminal electrodes 3 or between the region for the terminal electrodes 3 and the body 1, so the inner electrodes 2 and the terminal electrodes 3 are electrically connected. Therefore, in the ceramic laminated chip electronic elements of the present invention, regardless of the number or position of terminal electrodes 3, the structure wherein the ceramic body other than the region of the terminal electrodes has the ceramic glaze layer can be achieved without extra removing processes or tools. Furthermore, since there are no ceramic glaze layers on the surface of the region for the terminal electrodes 3 or between the region for the terminal electrodes 3 and the body 1, the inner electrodes 2 and the terminal electrodes 3 are well-connected with each other electrically; thus, the thickness of the ceramic glaze-coating structure is easily increased, and the abrasion and damage during the plating process is reduced, so as to be in accordance with the normal plating process, which is a major characteristic of the present invention.

### BRIEF DESCRIPTION OF THE DRAWINGS

FIG. 1A is a schematic plan view of a conventional ceramic laminated single-chip type electronic element;

FIG. 1B is a schematic plan view of a conventional ceramic laminated array-chip type electronic element;

FIG. 2A is a sectional view of the conventional ceramic laminated single-chip type and array-chip type electronic elements shown in FIGS. 1A and 1B taken along the section line A-A;

FIG. 2B1 is a sectional view of the conventional ceramic laminated single-chip type electronic element shown in FIG. 1A taken along the section line B-B;

FIG. 2B2 is a sectional view of the conventional ceramic laminated array-chip type electronic element shown in FIG. 1B taken along the section line B-B;

FIG. 3A is a sectional view of the conventional ceramic laminated single-chip type electronic element according to another embodiment shown in FIG. 1A taken along the section line A-A;

FIG. 3B1 is a sectional view of the conventional ceramic laminated single-chip type electronic element according to another embodiment shown in FIG. 1A taken along the section line B-B;

FIG. 3B2 is a sectional view of the conventional ceramic laminated array-chip type electronic element according to another embodiment shown in FIG. 1B taken along the section line B-B;

FIG. 3C is a sectional structural view of the conventional ceramic laminated single-chip type electronic element according to another embodiment shown in FIG. 1A taken along the section line A-A;

FIG. 4A is a sectional structural view of the conventional ceramic laminated single-chip type electronic element according to another embodiment shown in FIG. 1A taken along the section line A-A, and a sectional view of the conventional ceramic laminated array-chip type electronic element according to another embodiment shown in FIG. 1B taken along the section line A-A;

FIG. 4B1 is a sectional view of the conventional ceramic laminated single-chip type electronic element according to another embodiment shown in FIG. 1A taken along the section line B-B;

FIG. 4B2 is a sectional view of the conventional ceramic laminated array-chip type electronic element according to another embodiment shown in FIG. 1B taken along the section line B-B;

FIG. 5A is a sectional view of the ceramic laminated chip element of Taiwan Patent Publication No. 447775 of the applicant according to another embodiment shown in FIG. 1A taken along the section line A-A;

FIG. 5B1 is a sectional view of the ceramic laminated chip element in FIG. 7B1 of Taiwan Patent Publication No. 447775 of the applicant according to another embodiment shown in FIG. 1A taken along the section line 13-B;

FIG. 6 is a sectional view of the conventional ceramic laminated single-chip type electronic element according to another embodiment shown in FIG. 1A taken along the section line A-A;

FIG. 7A is a longitudinal sectional view of the single-chip type electronic element according to another embodiment of the present invention shown in FIG. 1A taken along the section line A-A;

FIG. 7B1 is a longitudinal sectional view of the array-chip type electronic element according to another embodiment of the present invention shown in FIG. 1B taken along the section line A-A;

FIG. 7B2 is a longitudinal sectional view of the array-chip type electronic element according to another embodiment of the present invention shown in FIG. 1B taken along the section line B-B; and

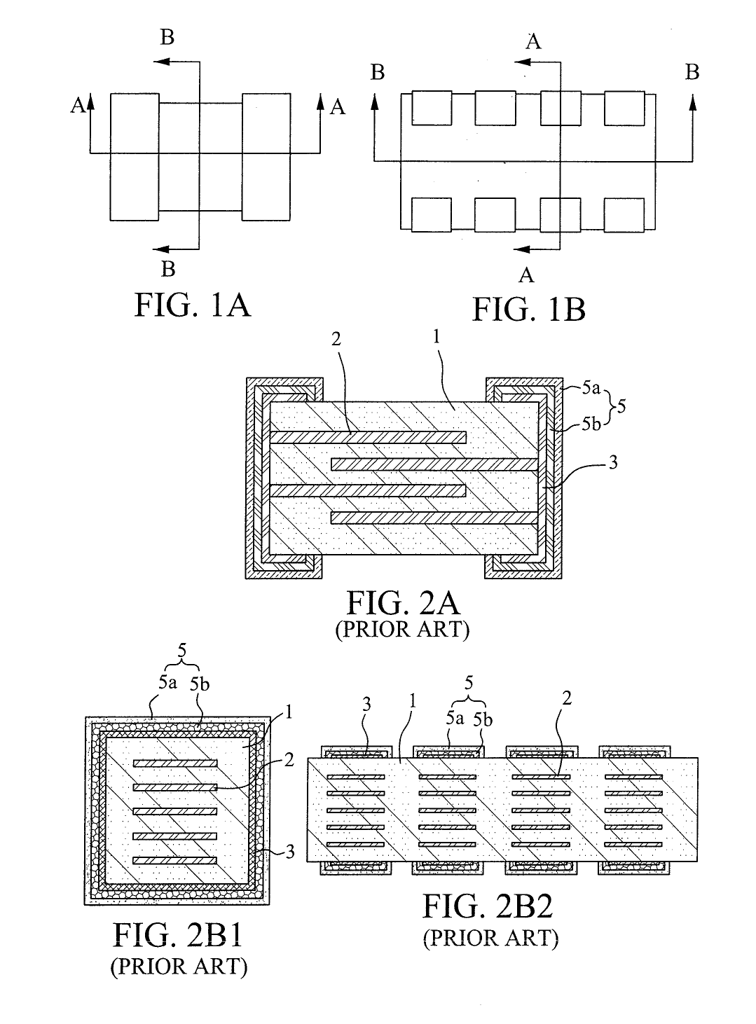

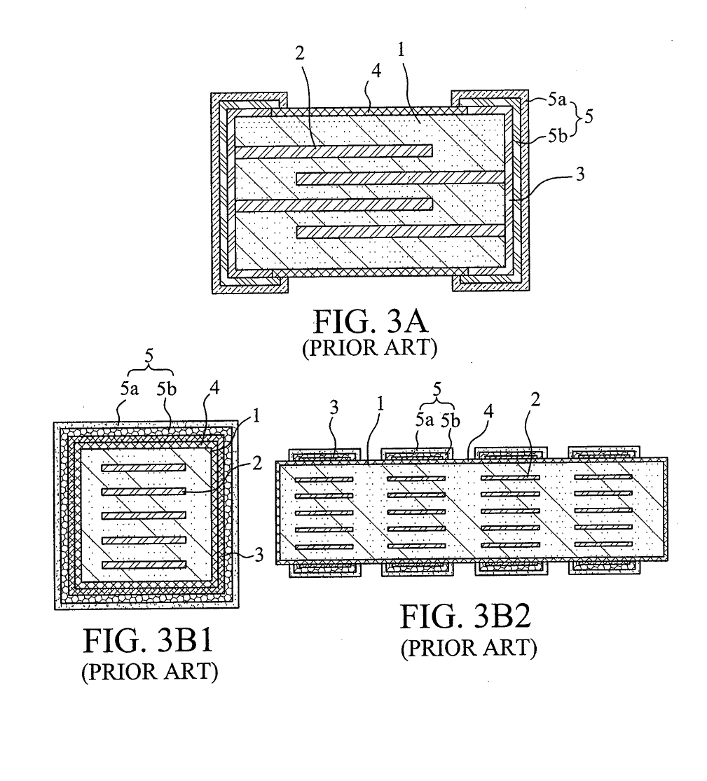

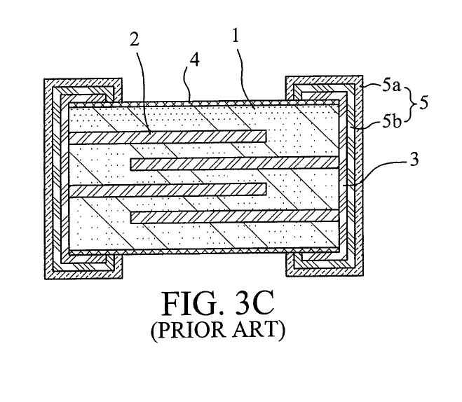

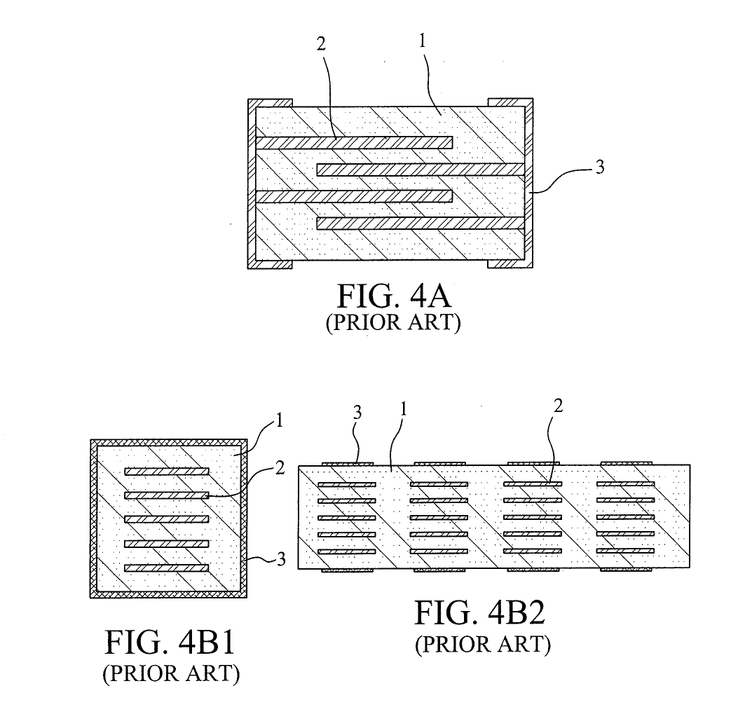

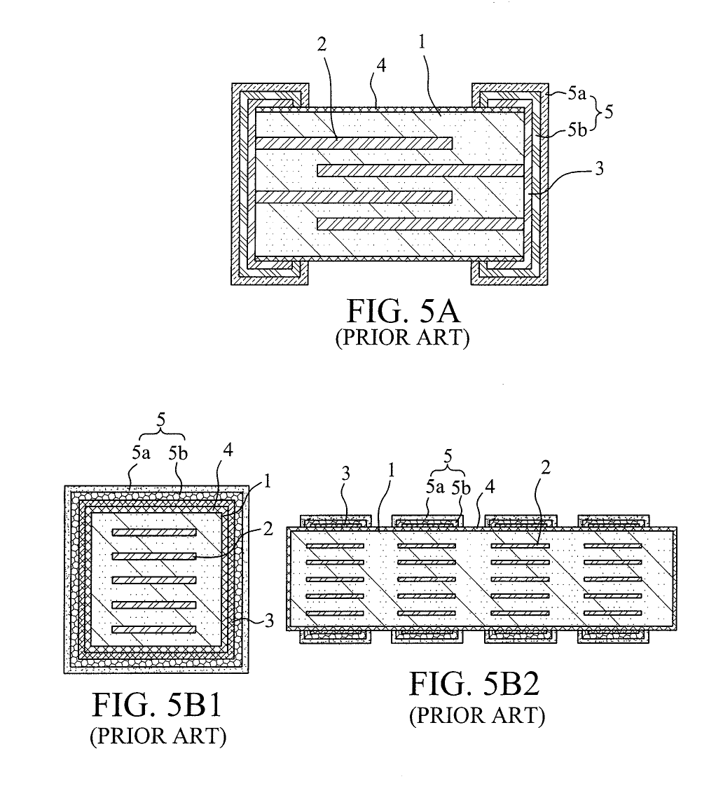

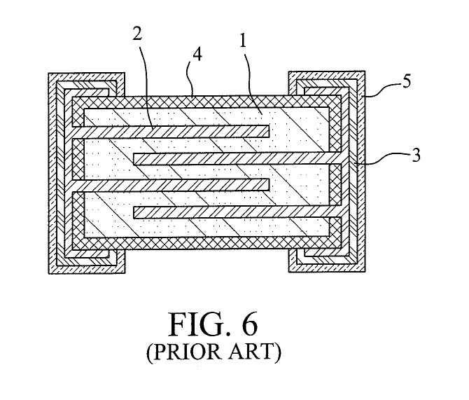

FIGS. 5A-5C are flow charts of the fabricating method according to three embodiments of the present invention.

### DETAILED DESCRIPTION

The present invention provides ceramic laminated single-chip type and array-chip type electronic elements having bodies made of semiconductor materials or materials without high-insulating resistance in order to provide a solution to the above-mentioned problems.

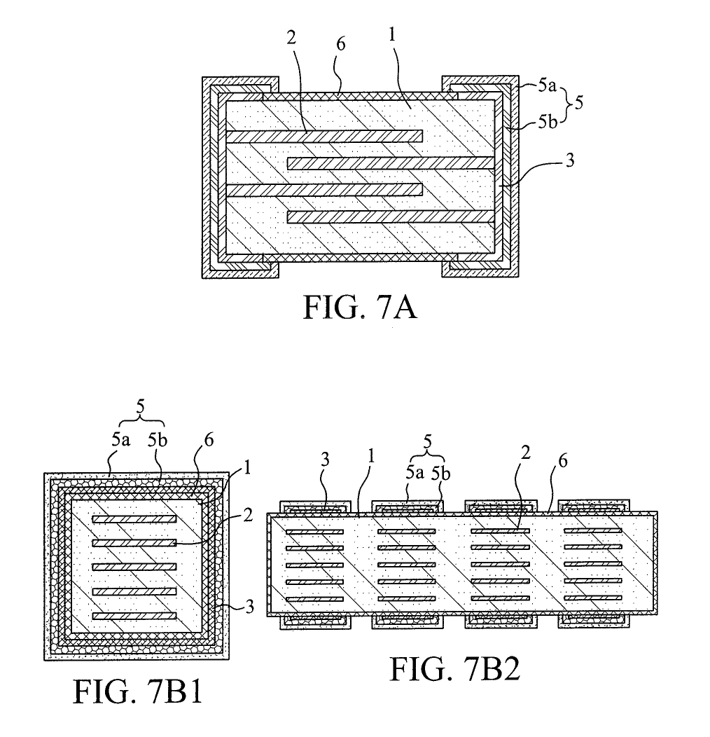

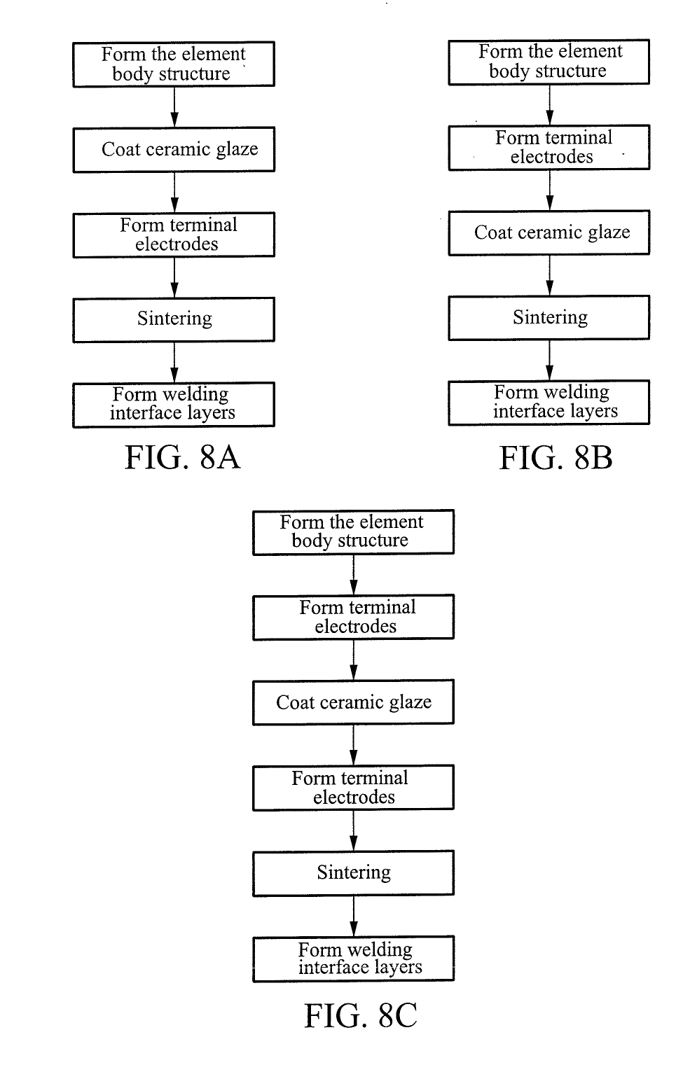

As for the ceramic glaze-coating stricture of ceramic laminated chip elements of the present invention, as shown in FIGS. 7A, 7B1, and 7B2, a layer of ceramic glaze is applied to the body 1 of the ceramic laminated chip element, wherein the body 1 is made of semi-conductive ceramic material or ceramic material without high-insulating resistance. A plurality of terminal electrodes 3 outside the body 1 is electrically connected with a plurality of inner electrodes 2 inside the body 1, and a plurality of welding interface layers 5 with a desirable welding properly is disposed outside the terminal electrodes 3.

The method according to a first embodiment of the present invention is as shown in FIG. 8A. A step of coating the body with a ceramic glaze is added after completing the step of forming the structure of the electronic element body with the material body 1 and the plurality of inner electrodes 2, and before the step of forming the structure of the plurality of terminal electrodes 3. This coating step is used to apply the ceramic glaze to all the surfaces of the entire element, no matter whether the structure of terminal electrodes 3 is completely or partially formed on the surface. Then, after the high-temperature sintering of the terminal electrodes 3, a plating process that is the same as the process for normal electronic elements is applied to form the terminal electrodes 3 having a plurality of welding interface layers 5 with a desirable welding property.

The method according to a second embodiment of the present invention is as shown in FIG. 5B. A step of coating the body with a ceramic glaze is added after completing the step of forming the structure of the electronic element body having the material body 1 and the plurality of inner electrodes 2, and after completing the step of forming the structure of the plurality of terminal electrodes 3. This coating step is used to apply the ceramic glaze to all the surfaces of the entire element, no matter whether the structure of terminal electrodes 3 is completely or partially formed on the surface. Then, after the high-temperature sintering of the terminal electrodes 3, a plating process that is the same as the process for normal electronic elements is applied to form the terminal electrodes 3 having a plurality of welding interface layers 5 with a desirable welding property.

The method according to a third embodiment of the present invention is as shown in FIG. 8C. After completing the step of forming the structure of the electronic element body with the material body 1 and the plurality of inner electrodes 2, a step of forming the structure of a plurality of terminal electrodes is performed before and after coating the body with the ceramic glaze. This coating step is used to apply the ceramic glaze to all the surfaces of the entire element, no matter whether the structure of the terminal electrodes 3 is completely or partially formed on the surface. Then, after the high-temperature sintering of the terminal electrodes 3, a plating process that is the same as the process for normal electronic elements is applied to form the terminal electrodes 3 having a plurality of welding interface layers 5 with a desirable welding property.

The present invention has at least the following efficacies.

1. The process for forming the ceramic glaze-coating structure of ceramic laminated single chip type and array-chip type electronic elements according to the present invention can be performed in batch mode, which achieves a large yield of elements with relatively low equipment cost, thus reducing the manufacturing cost of the elements.

2. As there is an insulating structure, terminal electrodes made of special materials are not required, and as there is a stricture of the ceramic glaze layer, various limitations on the fabrication of the welding-interface layers can be eliminated.

3. Due to the co-firing reaction of sintering and firing of the terminal electrodes and the ceramic glaze respectively, the ceramic glaze on the surface of the terminal electrodes, and that between the terminal electrodes and the ceramic body are absorbed by the terminal electrodes, which are not required to be removed through sand blasting, laser, grinding, etching, etc. Therefore, with the ceramic laminated chip elements of the present invention, no additional removing processes and tools are required regardless of the number and position of the terminal electrodes, so the ceramic glaze-coating structure can be adapted to be used in ceramic laminated electronic elements with an unlimited number of terminal electrodes at various positions.

4. After the ceramic glaze is sintered, its surface is relatively smooth, such that the surface of the ceramic glaze-coating layer is not embedded with any impurity, and as the ceramic glaze-coating layer is a high-density vitreous inorganic coating layer, it is resistant to organic solvents, moisture, vapor, flux, and a high temperature over 300° C.

5. The present invention is mainly directed to ceramic laminated chip elements having bodies made of semiconductive ceramic material or ceramic material without high-insulating resistance. The insulating structure not only eliminates limitations on the plating and welding interface layers of the terminal electrodes, but also provides a firm protection layer outside the body of the electronic element, thereby significantly enhancing the reliability of the electronic elements.

To sum up, the ceramic glaze-coating structure of ceramic laminated chip elements of the present invention indeed solves the limitation problem on the plating and welding interface layers for ceramic laminated chip elements with bodies made of semi-conductive ceramic material or ceramic material without high-insulating resistance, thereby improving the reliability of the elements. This structure is different from that of the conventional art, and the ceramic glaze has never been used to fabricate a ceramic laminated chip element with the same structure. As known by those skilled in the field of ceramic laminated single-chip type or array-chip type electronic elements, modifications without departing from the spirit of the present invention shall fall within the scope of the present invention.

1. (canceled)

2. (canceled)

3. (canceled)

4. (canceled)

5. A method of forming a ceramic glaze coating of a ceramic laminated chip element, comprising the following steps:
selecting an appropriate conductive composition;
selecting an appropriate first glaze; and
conducting a sintering reaction using the conductive composition with the first glaze to selectively remove a ceramic glaze on any part of the chip element.

6. The method of forming a ceramic glaze coating as claimed in claim 5, wherein the sintering reaction is used to remove the ceramic glaze on the plurality of terminal electrodes.

7. The method of forming a ceramic glaze coating as claimed in claim 5, wherein the sintering reaction is used to remove the ceramic glaze between the plurality of terminal electrodes and the body.

8. The method of forming a ceramic glaze coating as claimed in claim 5, wherein component elements for the first glaze or the ceramic glaze comprise at least B and Si.

9. The method of forming a ceramic glaze coating as claimed in claim 5, wherein a sintering temperature of the first glaze or the ceramic glaze is between 400° C. and 900° C.

10. The method of forming a ceramic glaze coating as claimed in claim 5, wherein the sintering reaction between the first glaze or the ceramic glaze and the terminal electrodes is at a temperature of between 400° C. and 900° C.

11. A method of forming a ceramic glaze coating of a ceramic laminated chip element, comprising the following steps:
forming an electronic element body with a material body and inner electrodes;
applying a ceramic glaze to the electronic element body;
forming a plurality of terminal electrodes on the electronic element body coated with the ceramic glaze;
conducting a sintering reaction using a conductive composition with a first glaze to selectively remove the ceramic glaze on the chip element; and
forming a plurality of welding interface layers on the terminal electrodes respectively.

12. The method of forming a ceramic glaze coating as claimed in claim 11, wherein the sintering reaction is used to remove the ceramic glaze on the plurality of terminal electrodes.

13. The method of forming a ceramic glaze coating as claimed in claim 11, wherein the sintering reaction is used to remove the ceramic glaze between the plurality of terminal electrodes and the body.

14. The method of forming a ceramic glaze coating as claimed in claim 11, wherein component elements for the first glaze or the ceramic glaze comprise at least B and Si.

15. The method of forming a ceramic glaze coating as claimed in claim 11, wherein a sintering temperature for the first glaze or the ceramic glaze is between 400° C. and 900° C.

16. The method of forming a ceramic glaze coating as claimed in claim 11, wherein the sintering reaction between the first glaze or the ceramic glaze and the terminal electrodes is at a temperature of between 400° C. and 900° C.

17. A method of forming a ceramic glaze coating of a ceramic laminated chip element, comprising the following steps:
forming an electronic element body with a material body and inner electrodes;
forming a plurality of terminal electrodes on the electronic element body;
applying a ceramic glaze to the electronic element body having the plurality of terminal electrodes;
conducting a sintering reaction using a conductive composition with a first glaze to selectively remove the ceramic glaze on the chip element; and
forming a plurality of welding interface layers on the terminal electrodes respectively.

18. The method of forming a ceramic glaze coating as claimed in claim 17, wherein the sintering reaction is used to remove the ceramic glaze on the plurality of terminal electrodes.

19. The method of forming a ceramic glaze coating as claimed in claim 17, wherein the sintering reaction is used to remove the ceramic glaze between the plurality of terminal electrodes and the body.

20. The method of forming a ceramic glaze coating as claimed in claim 17, wherein component elements of the first glaze or the ceramic glaze comprise at least B and Si.

21. The method of forming a ceramic glaze coating as claimed in claim 17, wherein a sintering temperature for the first glaze or the ceramic glaze is between 400° C. and 900° C.

22. The method of forming a ceramic glaze coating as claimed in claim 17, wherein the sintering reaction between the first glaze or the ceramic glaze and the terminal electrodes is between 400° C. and 900° C.

23. A method of forming a ceramic glaze coating of a ceramic laminated chip element, comprising the following steps:
forming an electronic element body having a material body and inner electrodes;
coating the electronic element body with a first ceramic glaze;
forming a plurality of terminal electrodes on the electronic element body coated with the ceramic glaze;
coating the electronic element body with a second ceramic glaze;
using a sintering reaction between a conductive composition and a first glaze to selectively remove the first and second ceramic glazes on the chip element; and
forming a plurality of welding-interface layers on the terminal electrodes respectively.

24. The method of forming a ceramic glaze coating as claimed in claim 23, wherein the sintering reaction is used to remove the ceramic glaze on the plurality of terminal electrodes.

25. The method of forming a ceramic glaze coating as claimed in claim 23, wherein the sintering reaction is used to remove the ceramic glaze between the plurality of terminal electrodes and the body.

26. The method of forming a ceramic glaze coating as claimed in claim 23, wherein component elements of the first glaze or the ceramic glaze comprise at least B and Si.

27. The method of forming a ceramic glaze coating as claimed in claim 23, wherein a sintering temperature for the first glaze or the ceramic glaze is between 400° C. and 900° C.

28. The method of forming a ceramic glaze coating as claimed in claim 23, wherein the sintering reaction between the first glaze or the ceramic glaze and the terminal electrodes is at a temperature of between 400° C. and 900° C.
